(19) United States
(12) Patent Application Publication
(10) Pub. No.: US 2025/0365678 A1
(43) Pub. Date: Nov. 27, 2025

(54) POWER HEADROOM (PH) REPORT FOR UPLINK TRANSMISSION

(71) Applicant: QUALCOMM Incorporated, San Diego, CA (US)

(72) Inventors: Ruiming ZHENG, Beijing (CN); Mostafa KHOSHNEVISAN, San Diego, CA (US); Ozcan OZTURK, San Diego, CA (US); Linhai HE, San Diego, CA (US)

(21) Appl. No.: 18/874,574

(22) PCT Filed: Aug. 10, 2022
(86) PCT No.: PCT/CN2022/111393

§ 371 Date: Dec. 12, 2024

(51) Int. Cl. H04W 52/36; H04W 52/40; H04W 52/42

(52) U.S. Cl. CPC H04W 52/365; H04W 52/40; H04W 52/42

(57) ABSTRACT

Certain aspects of the disclosure are directed to an apparatus for wireless communication. In some examples, the apparatus may be a user equipment (UE) configured to select a power headroom (PH) value associated with: a default PH configuration of the apparatus, a signal output for transmission to a first network node of a first serving cell of a first cell group, or the signal output for transmission to a second network node of the first serving cell of a first cell group. In some examples, the UE may output, for transmission to a second serving cell of a second cell group, a PH report comprising the selected PH value, wherein the PH report is output for transmission via a first slot.

### BACKGROUND

### Technical Field

The present disclosure generally relates to communication systems, and more particularly, to reporting a power headroom (PH) for repeated transmissions to multiple transmission/reception points (mTRPs).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus for wireless communication, comprising a memory comprising instructions and one or more processors configured to execute the instructions. In some examples, the apparatus is configured to select a power headroom (PH) value associated with: a default PH configuration of the apparatus, a signal output for transmission to a first network node of a first serving cell of a first cell group, or the signal output for transmission to a second network node of the first serving cell of a first cell group. In some examples, the apparatus is configured to output, for transmission to a second serving cell of a second cell group, a PH report comprising the selected PH value, wherein the PH report is output for transmission via a first slot. In some examples, the apparatus is configured to output the signal for transmission to the first network node or the second network node via at least one of the first slot or a second slot adjacent to the first slot.

Certain aspects are directed to an apparatus for wireless communication, comprising a memory comprising instructions and one or more processors configured to execute the instructions. In some examples, the apparatus is configured to output, for transmission to a user equipment (UE), an indication of a first network node of a first serving node or a second network node of the first serving cell, said first serving cell being part of a first cell group, the apparatus being part of a second serving cell of a second cell group. In some examples, the apparatus is configured to obtain, from the UE, a power headroom (PH) report comprising a PH value associated with: a default PH configuration of the UE, for communication with the indicated first network node or second network node, or a signal transmitted by the UE to the indicated first network node or second network node.

Certain aspects are directed to a method for wireless communication at a user equipment (UE). In some examples, the method includes selecting a power headroom (PH) value associated with: a default PH configuration of the UE, a signal output for transmission to a first network node of a first serving cell of a first cell group, or the signal output for transmission to a second network node of the first serving cell of a first cell group. In some examples, the method includes outputting, for transmission to a second serving cell of a second cell group, a PH report comprising the selected PH value, wherein the PH report is output for transmission via a first slot. In some examples, the method includes outputting the signal for transmission to the first network node or the second network node via at least one of the first slot or a second slot adjacent to the first slot.

Certain aspects are directed to a method for wireless communication at a network node. In some examples, the method includes outputting, for transmission to a user equipment (UE), an indication of a first network node of a first serving node or a second network node of the first serving cell, said first serving cell being part of a first cell group, the apparatus being part of a second serving cell of a second cell group. In some examples, the method includes obtaining, from the UE, a power headroom (PH) report comprising a PH value associated with: a default PH configuration of the UE, for communication with the indicated first network node or second network node, or a signal transmitted by the UE to the indicated first network node or second network node.

Certain aspects are directed to a user equipment (UE). In some examples, the UE includes means for selecting a power headroom (PH) value associated with: a default PH configuration of the UE, a signal output for transmission to a first network node of a first serving cell of a first cell group, or the signal output for transmission to a second network node of the first serving cell of a first cell group. In some examples, the UE includes means for outputting, for transmission to a second serving cell of a second cell group, a PH report comprising the selected PH value, wherein the PH report is output for transmission via a first slot. In some examples, the UE includes means for outputting the signal for transmission to the first network node or the second network node via at least one of the first slot or a second slot adjacent to the first slot.

Certain aspects are directed to a network node. In some examples, the network node includes means for outputting, for transmission to a user equipment (UE), an indication of a first network node of a first serving node or a second network node of the first serving cell, said first serving cell being part of a first cell group, the apparatus being part of a second serving cell of a second cell group. In some examples, the network node includes means for obtaining, from the UE, a power headroom (PH) report comprising a PH value associated with: a default PH configuration of the UE, for communication with the indicated first network node or second network node, or a signal transmitted by the UE to the indicated first network node or second network node.

Certain aspects are directed to a non-transitory computer-readable medium comprising instructions that, when executed by an apparatus, cause the apparatus to perform operations. In some examples, the operations include selecting a power headroom (PH) value associated with: a default PH configuration of the UE, a signal output for transmission to a first network node of a first serving cell of a first cell group, or the signal output for transmission to a second network node of the first serving cell of a first cell group. In some examples, the operations include outputting, for transmission to a second serving cell of a second cell group, a PH report comprising the selected PH value, wherein the PH report is output for transmission via a first slot. In some examples, the operations include outputting the signal for transmission to the first network node or the second network node via at least one of the first slot or a second slot adjacent to the first slot.

Certain aspects are directed to a non-transitory computer-readable medium comprising instructions that, when executed by an apparatus, cause the apparatus to perform operations. In some examples, the operations include outputting, for transmission to a user equipment (UE), an indication of a first network node of a first serving node or a second network node of the first serving cell, said first serving cell being part of a first cell group, the apparatus being part of a second serving cell of a second cell group. In some examples, the operations include obtaining, from the UE, a power headroom (PH) report comprising a PH value associated with: a default PH configuration of the UE, for communication with the indicated first network node or second network node, or a signal transmitted by the UE to the indicated first network node or second network node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram of an example network including a first cell group (e.g., CG1) and a second cell group in communication with a UE.

FIG. 6 is a block diagram illustrating a dual connectivity UE and cell group network and an example communication of repeated uplink transmissions and transmission of a power headroom (PH) report.

FIG. 7 is a block diagram illustrating an example communication of repeated uplink transmissions and transmission of a PH report using the same dual connectivity UE and cell group network of FIG. 6.

FIG. 8 is a block diagram illustrating an example communication of repeated uplink transmissions and transmission of a PH report using the same dual connectivity UE and cell group network of FIG. 6.

FIG. 9 is a flowchart of a method of wireless communication.

FIG. 10 is a diagram illustrating an example of a hardware implementation for an example apparatus.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In certain aspects, a user equipment (UE) may be configured to transmit repeated uplink signaling to multiple transmission/reception points (mTRPs). For example, the UE may transmit an uplink signal via a first beam to a first TRP, and transmit the same signal via a second beam to a second TRP. The repeated transmission of the same signal via multiple beams may be performed in a time-division multiplexing (TDM) TDM manner.

Radio resource control (RRC) parameter twoPHRMode is configured in PHR-Config under the medium access control (MAC) CellGroupConfig to indicate whether a power headroom (PH) for the repeated transmissions shall be reported as two PH values (e.g., with a first PH value associated with the signal transmitted to the first TRP, and the second PH value associated with the signal transmitted to the second TRP). Here, twoPHRMode may indicate whether both the PH values should be reported in a single PH report.

For example, if the UE is configured for twoPHRMode, then the UE may determine an actual or virtual PH value for each transmission to the mTRPs. A virtual PH value may be a default PH value (e.g., configured by the network at the UE) indicating a maximum transmission power of the UE as configured by a cell group (e.g., master cell group MCG), and an actual PH value (e.g., a difference between a maximum transmission power and a transmission power used to transmit a signal). In some examples, the actual PH value may indicate how much transmission power is left for the UE to use in addition to the power being used by a current transmission. The PH values may be reported to the network via an enhanced MAC control element (MAC-CE) that includes fields for multiple PH values. The enhanced MAC-CE may also include one or more fields indicating whether a particular PH value is a virtual PH value or an actual PH value.

Of course, whether a network configures the UE to enable twoPHRMode may depend on whether the UE is capable of reporting two or more PH values in a single PH report. Thus, the UE may indicate its capability via an information element (IE) mTRP-PUSCH-twoPHR-Reporting-r17. The UE may use this IE to indicates its support of calculating two PH values associated with uplink transmissions to mTRPs. For example, if the UE is capable, the UE may transmit a PH report comprising a first PH value and a second PH value, wherein both values correspond to uplink transmissions made over the same component carrier to different TRPs associated with the same serving cell.

However, it is possible that in a dual connectivity scenario, the twoPHRMode is configured for one MAC entity while not being configured for another MAC entity. In such a case, the MAC entity not configured for twoPHRMode may not be capable of parsing the enhanced MAC-CE. Thus, if the MAC-CE to which the PH report is transmitted cannot support twoPHRMode, then the PH report may be of a legacy format (e.g., only include one PH value for a serving cell). That is, if the UE transmits signal repetitions to multiple TRPs of a first cell in a first cell group configure for twoPHRMode but transmits a PH report of the transmissions to a second cell group that is not configured for twoPHRMode, then only one PH value of one of the transmissions may be included in the PH report. Thus, aspects of the disclosure are directed to defining which of the PH values associated mTRP uplink transmissions should be included in the PH report.

In certain aspects, a first cell group may be configured with one or more serving cells including a first serving cell. The first cell group may be configured to receive and decode a PH report comprising multiple PH values of a serving cell. However, a second cell group comprising a second cell may not be configured to receive and decode a PH report comprising multiple PH values of a serving cell. Instead, the second cell group may be configured to receive a PH report comprising only one PH value per serving cell. Thus, if a UE transmits a repeated uplink transmission to two TRPs (e.g., network nodes) of the first serving cell, the UE may transmit a PH report containing an indication of a PH value associated with one of the uplink transmissions to the second serving cell but omit a PH value associated with the other uplink transmission from the PH report.

In a first example, if the UE only transmits one uplink signal to a first TRP or a second TRP, but no other uplink transmission is made after that, then the UE may include the PH value associated with the uplink transmission to the first TRP or the second TRP in the PH report. Here, only one uplink transmission is made, so only one PH value is reported, and no other PH values are omitted. Here, the PH value may be an actual PH value (e.g., a difference between a maximum transmit power available to the UE for transmission to the first TRP and the transmit power used by the UE for the uplink transmission) if the PH report is transmitted in the same slot used to transmit the uplink transmission.

In a second example, the UE may report the PH value associated with the uplink transmission that is first in time. For example, if an uplink transmission to a first TRP of the first serving cell occurs during a first slot, and an uplink transmission to a second TRP of the first serving cell occurs during a second slot that comes after the first slot, the UE may include only a PH value associated with the uplink transmission to the first TRP in the PH report. Here, the PH value may be an actual PH value (e.g., a difference between a maximum transmit power available to the UE for transmission to the first TRP and the transmit power used by the UE for the uplink transmission) if the PH report is transmitted in the same slot used to transmit the uplink transmission.

In a third example, the UE may report a virtual PH value if the uplink transmission occurs in a slot after the PH report is transmitted. In such an example, the virtual PH value may correspond to a default PH configuration of the UE.

In a fourth example, the UE may transmit two uplink communications: one to a first TRP of the first serving cell, and one to a second TRP of the first serving cell, wherein both uplink communications are transmitted in a first slot. The UE may also transmit the PH report to the second serving cell in the first slot. In such an example, the UE may generate a PH report that includes a PH value for the uplink transmission that came first in time, or a PH value for the uplink transmission that corresponds to a particular TRP identified by the second serving cell. For example, the second serving cell may transmit a message (e.g., radio resource control (RRC) message) to the UE, wherein the message identifies a particular TRP of the first serving cell. The UE may then include the PH value associated with the uplink transmission to the particular TRP in the PH report, while omitting the PH value associated with the uplink transmission to the other TRP.

In a fifth example, the second serving cell may configure the UE to report only an actual PH value in the PH report for a particular TRP. In this example, the UE may be configured to transmit an actual PH value associated with an uplink transmission to the particular TRP even if the uplink transmission occurs after transmission of the PH report.

In a sixth example, the UE may transmit a PH report that includes a field configured to indicate the TRP to which a PH value is associated. For example, if the UE transmits an uplink signal to a first TRP, and the first signal is defined by a first PH value, then the PH report may include the first PH value and an indication identifying the first TRP and associated with the first PH value.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

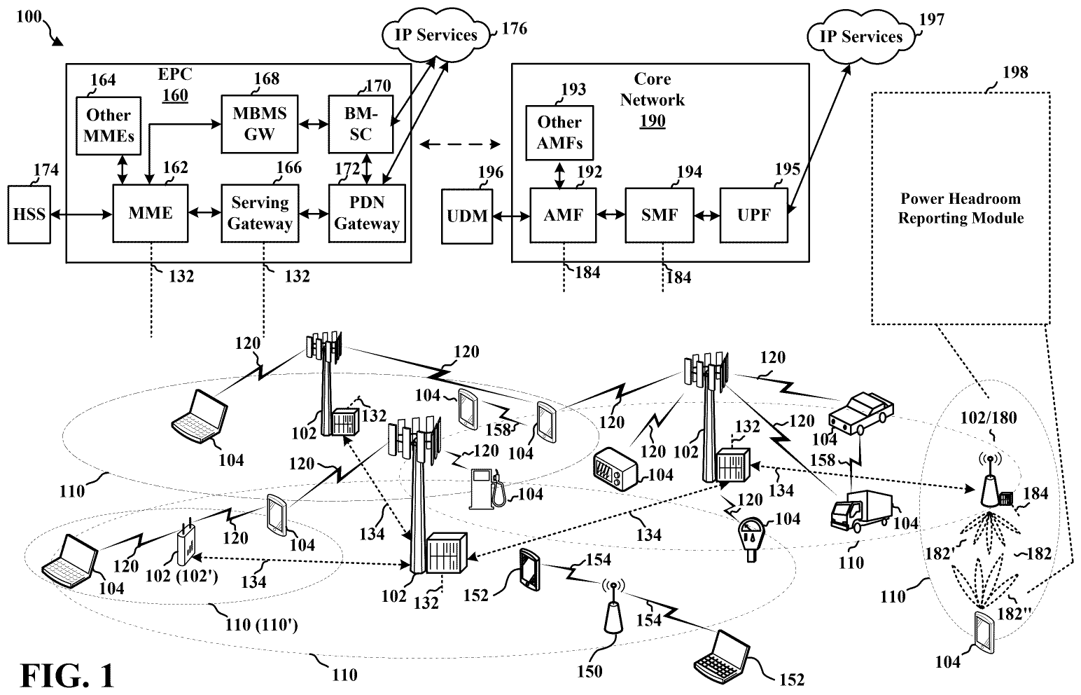

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a power headroom (PH) reporting module 198. In some examples, the PH reporting module 198 is configured to select a power headroom (PH) value associated with: a default PH configuration of the apparatus, a signal output for transmission to a first network node of a first serving cell of a first cell group, or the signal output for transmission to a second network node of the first serving cell of a first cell group. The PH reporting module 198 may also be configured to output, for transmission to a second serving cell of a second cell group, a PH report comprising the selected PH value, wherein the PH report is output for transmission via a first slot. The PH reporting module 198 may also be configured to output the signal for transmission to the first network node or the second network node via at least one of the first slot or a second slot adjacent to the first slot.

In certain aspects, the BS 102 may include the PH reporting module 198. In such an example, the PH reporting module 198 may be configured to output, for transmission to a user equipment (UE), an indication of a first network node of a first serving node or a second network node of the first serving cell, said first serving cell being part of a first cell group, the apparatus being part of a second serving cell of a second cell group. The PH reporting module 198 may also be configured to obtain, from the UE, a power headroom (PH) report comprising a PH value associated with: a default PH configuration of the UE, for communication with the indicated first network node or second network node, or a signal transmitted by the UE to the indicated first network node or second network node.

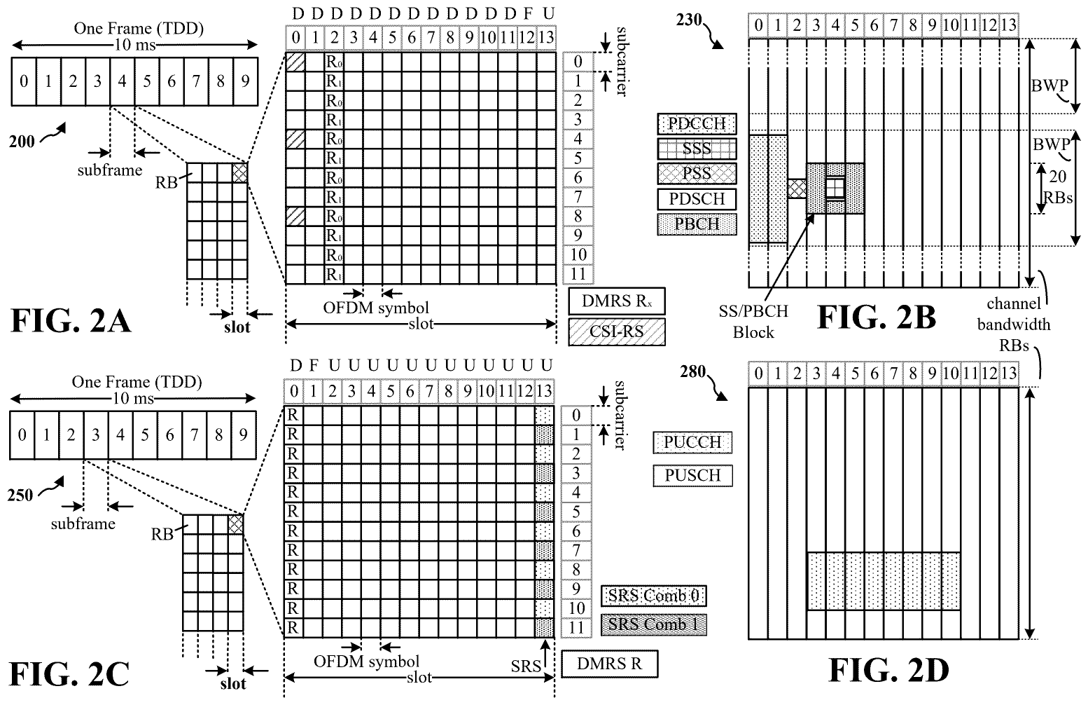

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

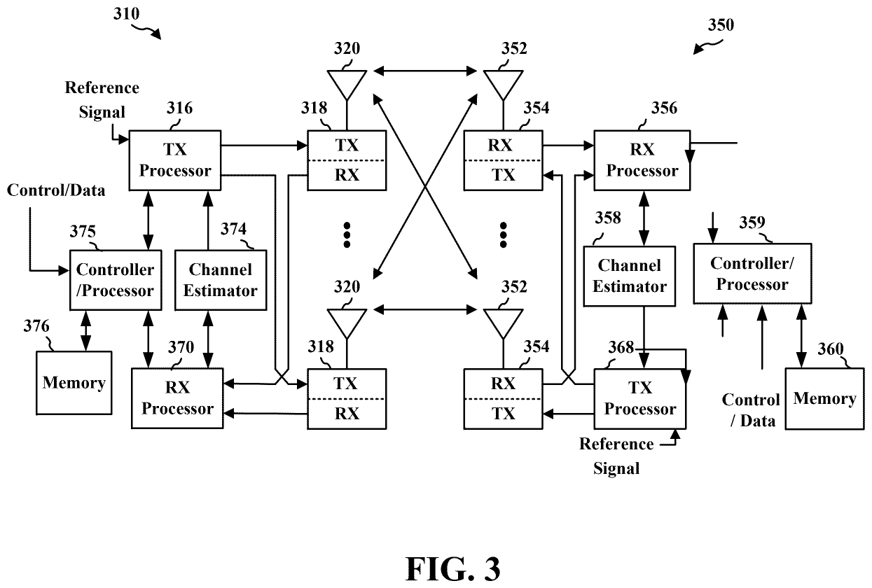

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

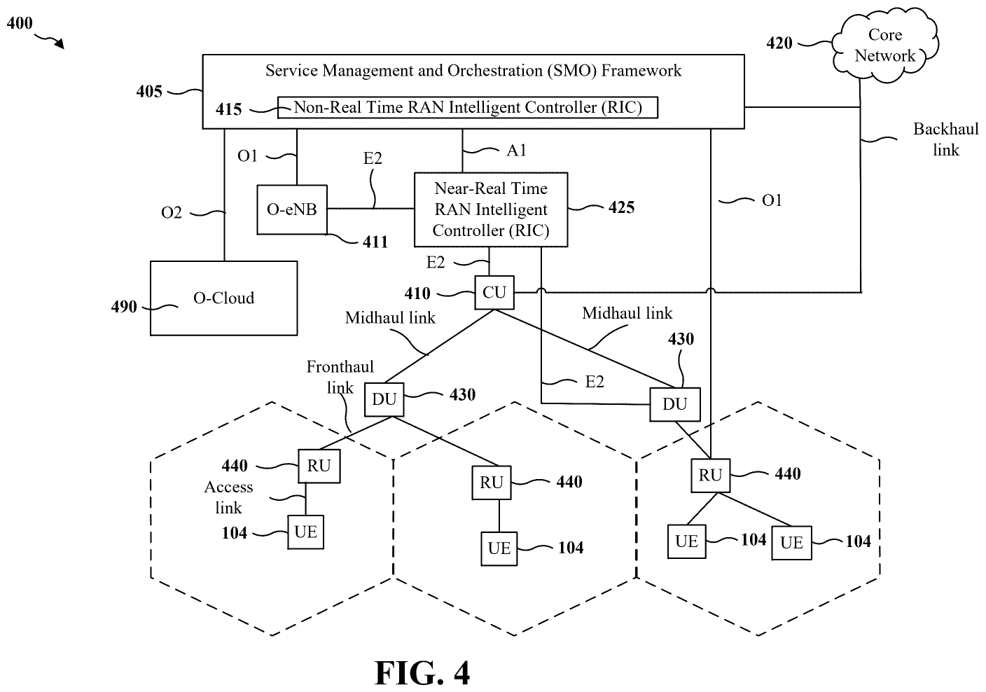

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

As long as the MAC entity (e.g., cell group) that a PH report is transmitted to is not twoPHRMode configured for new radio dual connectivity (NR-DC), E-UTRAN new radio dual connectivity (EN-DC), or new radio E-UTRA dual connectivity (NE-DC), a legacy PH report may be generated. This is because if the PH report carrying multiple PH values for a single serving cell is transmitted, the MAC entity may not be able to properly decode the PH report. Thus, there is a need for the UE to determine which of the multiple PH values to transmit to the MAC entity.

### Example of a Network for Communication of PH Values

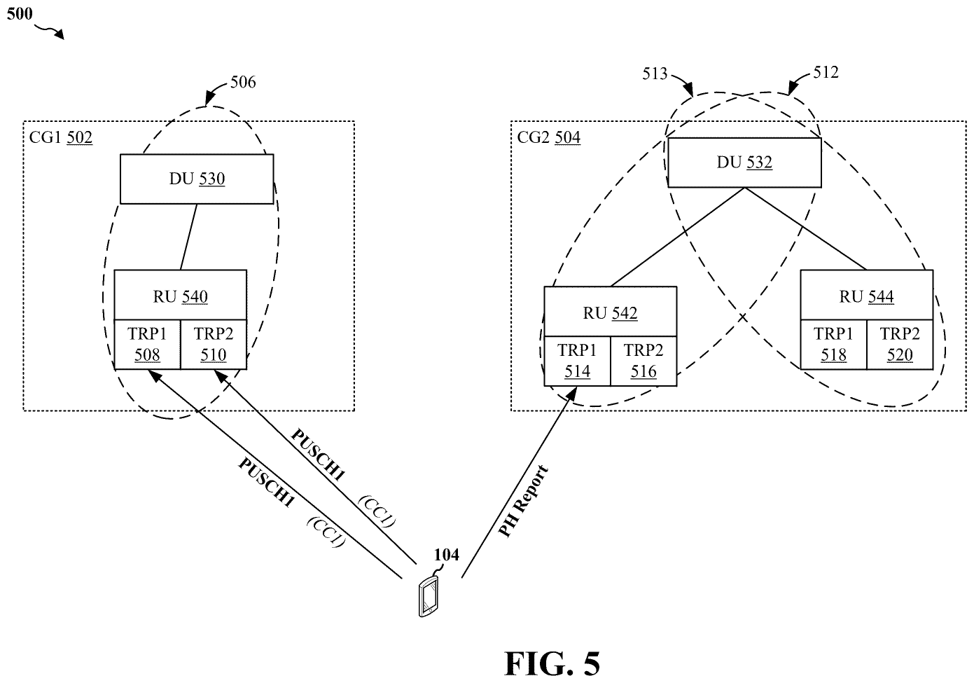

FIG. 5 is a block diagram of an example network 500 including a first cell group 502 (e.g., CG1) and a second cell group 504 in communication with a UE 104. The first cell group 502 includes a first DU 530 (e.g., DU 430 of FIG. 4) that configured as a MAC entity of the first cell group 502. The first cell group 502 may include one or more serving cells but is illustrated as including a first serving cell 506 for brevity. The first serving cell may be configured as a PCell, PSCell, SCell, etc. The first serving cell 506 includes the first DU 530 in communication with a first RU 540 (e.g., RU 440 of FIG. 4). Although an RU may include one or more TRPs, the first RU 540 is illustrated with a first TRP 508 (TRP1) and a second TRP 510 (TRP2). Both TRPs may communicate with the UE 104 using a same component carrier (e.g., CC1).

The second cell group 504 may include one or more serving cells, and is illustrated as including a second serving cell 512 and a third serving cell 513. Each of the serving cells may be configured as a PCell, PSCell, SCell, etc. The second serving cell 512 includes a second DU 532 configured as a MAC entity for the second cell group 504, a second RU 542, and a first TRP 514 (TRP1) and a second TRP 516 (TRP2). The second cell group 504 also includes a third serving cell 513 that includes the second DU 532, a third RU 544, and a first TRP 518 (TRP1) and a second TRP 520 (TRP2).

The TRPs described herein may be an integrated aspect of their respective RUs. For example, one or more TRPs may be a group of antenna elements in an antenna array of the RU, wherein the group comprises equal to or less than all of the antenna elements. In some examples, the TRPs may be implemented as a separate antenna array external to the RU. As used herein, a TRP may be referred to as a “network node.”

In this example, the UE 104 is configured for communication with both of the first TRP 508 and the second TRP 510 of the first serving cell 506 via a first component carrier (CC1). That is, the UE 104 may transmit uplink communications (e.g., PUSCH, PUCCH, etc.) to the first serving cell 506 via two communication links. The UE 104 is also configured for communication with the second serving cell 512. In this example, the UE 104 may be communicating directly with the second RU 542 or directly with the first TRP 514. In some examples, the first DU 530 and the second DU 532 may be managed by the same CU (e.g., CU 410 of FIG. 4).

Here, the UE 104 may transmit a repeated signal in PUSCH transmissions (PUSCH1) to one or more of the first TRP 508 and the second TRP 510. In other words, the UE 104 may transmit a signal to one TRP, then transmit the same signal to another TRP via the same component carrier. The UE 104 may also transmit a PH report (PHR) to the second serving cell 512, reporting a PH value for one of the transmission to the first TRP 508 or the transmission to the second TRP 510.

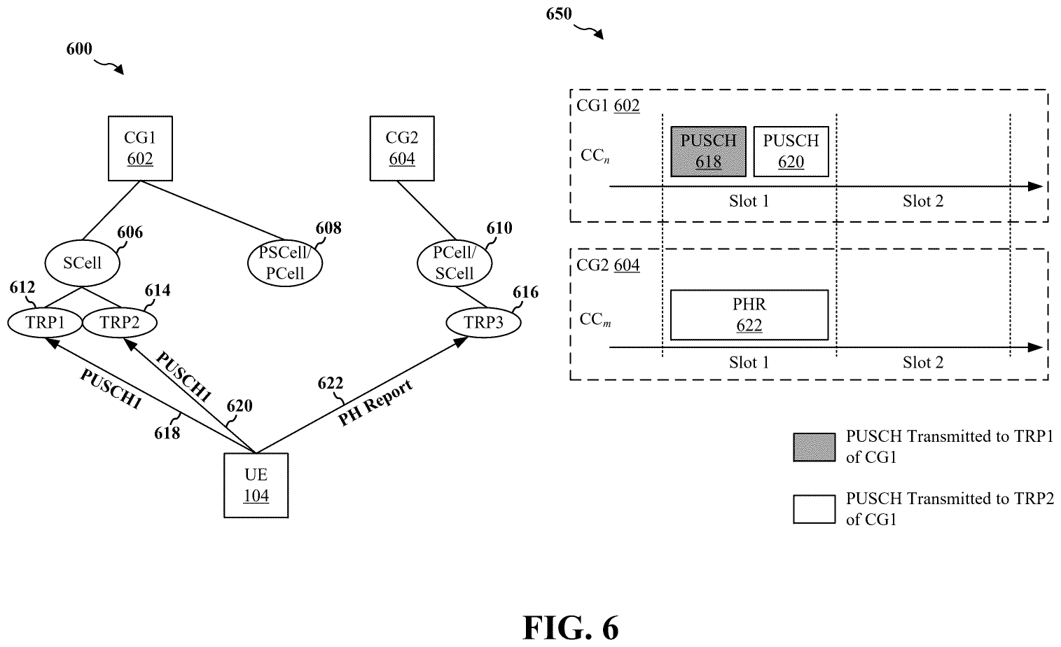

FIG. 6 is a block diagram illustrating a dual connectivity UE 104 and cell group network 600 and an example communication 650 of repeated uplink transmissions and transmission of a PH report 622.

The first cell group 602 (CG1) (e.g., first cell group 502 of FIG. 5) may include one or more serving cells, illustrated as an SCell 606 and a PSCell/PCell 608. The first cell group 602 may operate as a secondary cell group (SCG). The SCell 606 may include one or more TRPs, illustrated as a first TRP 612 (TRP1) and a second TRP 614 (TRP2). The second cell group 604 (CG2) (e.g., second cell group 504 of FIG. 5) may include one or more serving cells, illustrated as a PCell/SCell 610 and a third TRP 616 (TRP3). The second cell group 604 may operate as a master cell group (MCG).

In this example, the first cell group 602 is twoPHRMode configured, meaning that the UE 104 may calculate two PH values: one for an uplink transmission to the first TRP 612, and one for an uplink transmission to the second TRP 614, wherein both TRPs are in the same serving cell, and report both PH values in the same PH report. However, the second cell group 604 is not twoPHRMode configured, meaning that the second cell group 604 would not be able to receive and properly decode a PH report that includes multiple (e.g., two) PH values for each serving cell. Thus, in this example, if the UE 104 is transmitting the PH report to the serving cell of the second cell group 604, the UE 104 may still transmit an uplink communication to the multiple TRPs of the first cell group 602, but the UE 104 may calculate and report only one PH value to the serving cell 610 of the second cell group 604. The following examples provide techniques and methods for which PH value the UE 104 may calculate and report for a multiple uplink transmission scenario wherein the second cell group 604 is not twoPHRMode configured.

Initially, the serving cell 610 in second cell group may provide an uplink grant to the UE 104, providing the UE 104 with resources in the first slot (slot 1) for transmitting the PH report 622. As illustrated, the UE 104 may transmit repeated instances of an uplink signal (e.g., PUSCH1) to the first cell group 602. Specifically, the UE 104 may transmit a first uplink signal 618 to the first TRP 612, and transmit a second uplink signal 620 to the second TRP 614. The first uplink signal 618 and the second uplink signal 620 may be multiple transmissions be the same signal. The UE may also transmit the PH report containing PH values associate with one of the first uplink signal 618 or the second uplink signal 620.

The uplink communication 650 illustrates a first example of repeated uplink transmissions by the UE 104. As shown, the UE 104 may transmit the first uplink signal 618 to the first TRP 612 and the second uplink signal 620 to the second TRP 614 over the same component carrier (CCₙ) and within the same slot (slot 1). Here, the first uplink signal 618 is transmitted first in time relative to the second uplink signal 620. The UE 104 may also transmit a PH report 622 containing a PH value for one of the first uplink signal 618 or the second uplink signal 620 to the third serving cell 610 of the second cell group via the same slot (slot 1) using another component carrier (CCₘ).

This in this first example, the UE 104 may report an actual PH value for the first uplink transmission 618 to the first TRP 612 in the PH report 622 because the first transmission is first in time relative to the second uplink transmission 620. That is, the UE 104 may be configured to transmit only the PH value associated with an uplink transmission that is first in time in a scenario where two uplink transmissions are made during the same slot. Alternatively, the third serving cell 610 of the second cell group 604 may configure the UE 104 to transmit a PH value associated with a particular TRP (e.g., the first TRP 612 or the second TRP 614). For example, the third serving cell 610 may transmit an RRC message to the UE 104 identifying the particular TRP.

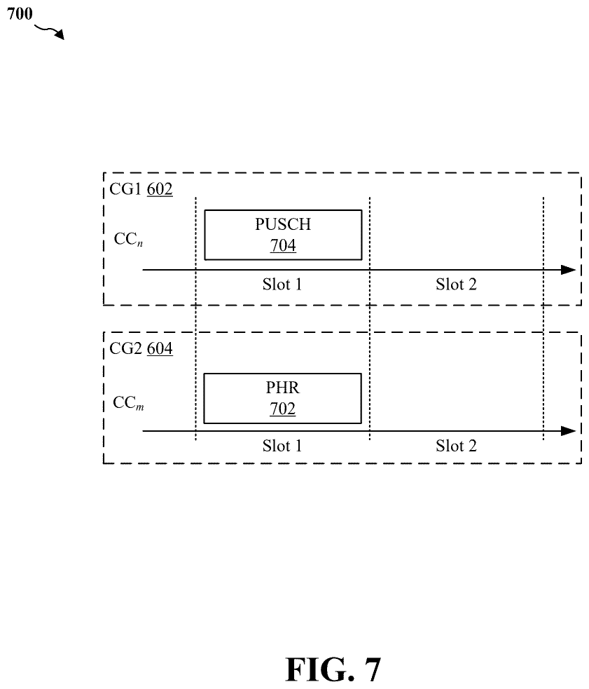

FIG. 7 is a block diagram illustrating an example communication 700 of repeated uplink transmissions and transmission of a PH report 702 using the same dual connectivity UE 104 and cell group network 600 of FIG. 6.

Here, the UE 104 transmits an uplink signal 704 to the first serving cell 606 (e.g., via the first TRP 612 or the second TRP 614) during a first slot (slot 1). However, the UE 104 does not make an additional transmission in the first slot or the next slot (slot 2). The UE 104 also transmits a PH report 702 during the first slot.

In this example, the UE 104 may be configured to include an actual PH value for the transmitted uplink signal 704 in the PH report 702. That is, in this scenario, the UE 104 may be configured to report an actual PH value for the uplink signal that is transmitted first in time. In other words, the UE 104 may report the actual PH value of the uplink signal 704 because the actual transmission of the uplink signal 704 happens in the same slot (slot 1) where the PH report 702 transmitted.

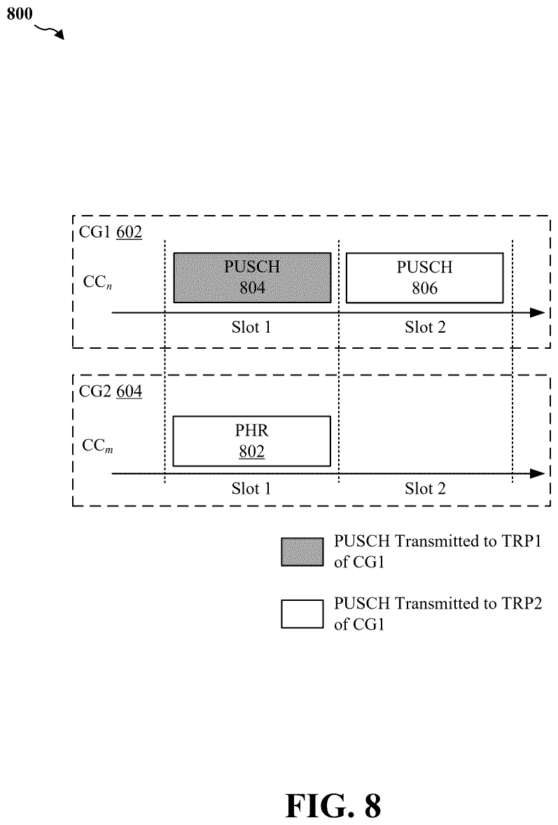

FIG. 8 is a block diagram illustrating an example communication 800 of repeated uplink transmissions and transmission of a PH report 802 using the same dual connectivity UE 104 and cell group network 600 of FIG. 6.

Here, the UE 104 transmits a first uplink signal 804 during a first slot, and a second uplink signal 806 during a second slot to the first serving cell 606. The first uplink signal 804 may be transmitted to the first TRP 612, and the second uplink signal 806 may be transmitted to the second TRP 614. Both uplink signals may be transmitted via a common component carrier (CCₙ). The UE 104 may also transmit a PH report 802 to the third serving cell 610 during the first slot using another component carrier (CCₘ).

In this example, the UE 104 may be configured to include an actual PH value for the transmitted first uplink signal 804 in the PH report 802. That is, in this scenario, the UE 104 may be configured to report an actual PH value for the uplink signal that is transmitted first in time (e.g., the first uplink signal 804 instead of the second uplink signal 806). In other words, the UE 104 may report the actual PH value of the first uplink signal 804 instead of the second uplink signal 806 because the actual transmission of the first uplink signal 804 happens in the same slot (slot 1) where the PH report 802 transmitted.

Accordingly, in some examples, the PH report may include an actual PH value associated with an uplink signal that is transmitted in the same slot as the PH report. For instance, in the examples of FIGS. 7 and 8, the UE 104 may report the actual PH value for the first (earliest in time) uplink signal associated with one SRS resource set (e.g., TRP) that overlaps in time (e.g., same slot) with a PUSCH that carries a PH report.

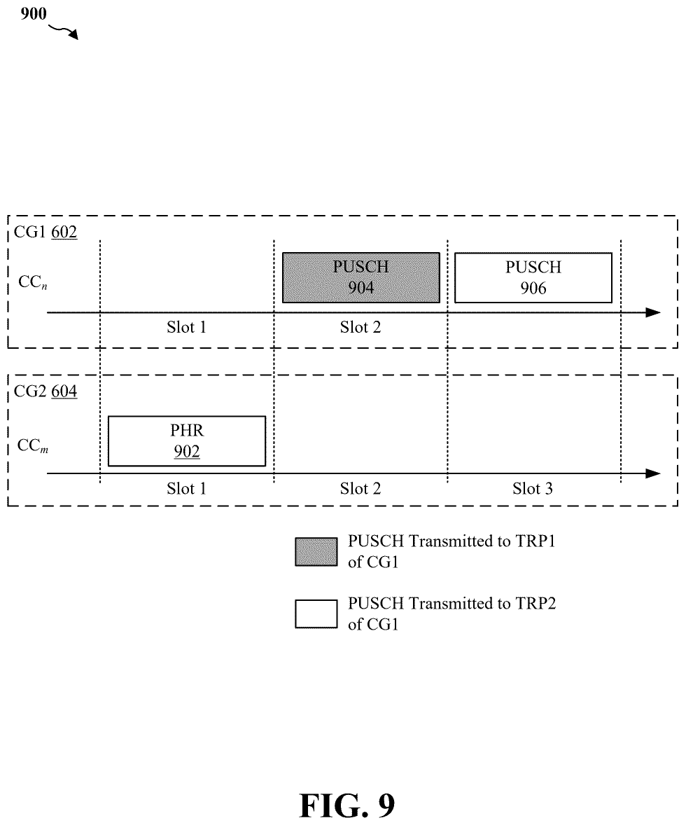

FIG. 9 is a block diagram illustrating an example communication 900 of repeated uplink transmissions and transmission of a PH report 902 using the same dual connectivity UE 104 and cell group network 600 of FIG. 6.

Here, the UE 104 transmits a first uplink signal 904 during a second slot (slot 2), and a second uplink signal 906 during a third slot (slot 3) to the first serving cell 606. The first uplink signal 904 may be transmitted to the first TRP 612, and the second uplink signal 906 may be transmitted to the second TRP 614. Both uplink signals may be transmitted via a common component carrier (CCₙ). The UE 104 may also transmit a PH report 902 to the third serving cell 610 during the first slot (slot 1) using another component carrier (CCₘ).

In this example, the UE 104 may be configured to include a virtual PH value in the PH report 802. That is, because there is no uplink transmission in the first slot, the UE 104 may be configured to report a virtual PH value for first slot because it does not yet know the actual PH values of either of the first uplink signal 904 or the second uplink signal 906. The virtual PH value may be a default PH configuration associated with the first TRP 612 or the second TRP 614. In some examples, the virtual PH value reported is the value associated with the TRP to which an uplink signal will be transmitted first in time. In the example illustrated, the UE 104 may transmit a virtual PH value corresponding to the first TRP 612 in the PH report 902. Alternatively, the third serving cell 610 of the second cell group 604 may configure the UE 104 to transmit a virtual PH value associated with a particular TRP (e.g., the first TRP 612 or the second TRP 614). For example, the third serving cell 610 may transmit an RRC message the UE 104 identifying the particular TRP.

In any of the examples illustrated in FIGS. 6-9, the UE 104 may be configured by the third serving cell 610 to transmit a PH report containing an actual PH value corresponding to a particular TRP. That is, even if an uplink signal is not transmitted to the particular TRP until a slot subsequent to the PH report 902, the UE 104 may be configured to determine an actual PH value associated with the uplink signal prior to its transmission. Here, the third serving cell 610 may configure the UE 104 with the particular TRP via a radio resource control (RRC) message.

In any of the examples illustrated in FIGS. 6-9, the UE 104 may be configured by the third serving cell 610 to transmit a PH report containing only a virtual PH value associated with a repeated signal uplink transmission. For example, the UE 104 may transmit a PH report containing one or more virtual values associated with transmissions to one or more TRPs (e.g., the first TRP 612 and/or the second TRP 614) in the first serving cell 606. Here, the third serving cell 610 may configure the UE 104 with an indication (e.g., phr-ModeOtherCG) of the particular TRP(s) for which to provide virtual PH values via a radio resource control (RRC) message.

In some examples, the PH report of any of examples 6-9 may be transmitted using a MAC-CE format. In some examples, the MAC-CE format may include an additional field enabling the UE 104 to identify the TRP associated with a particular actual or virtual PH value included in the MAC-CE.

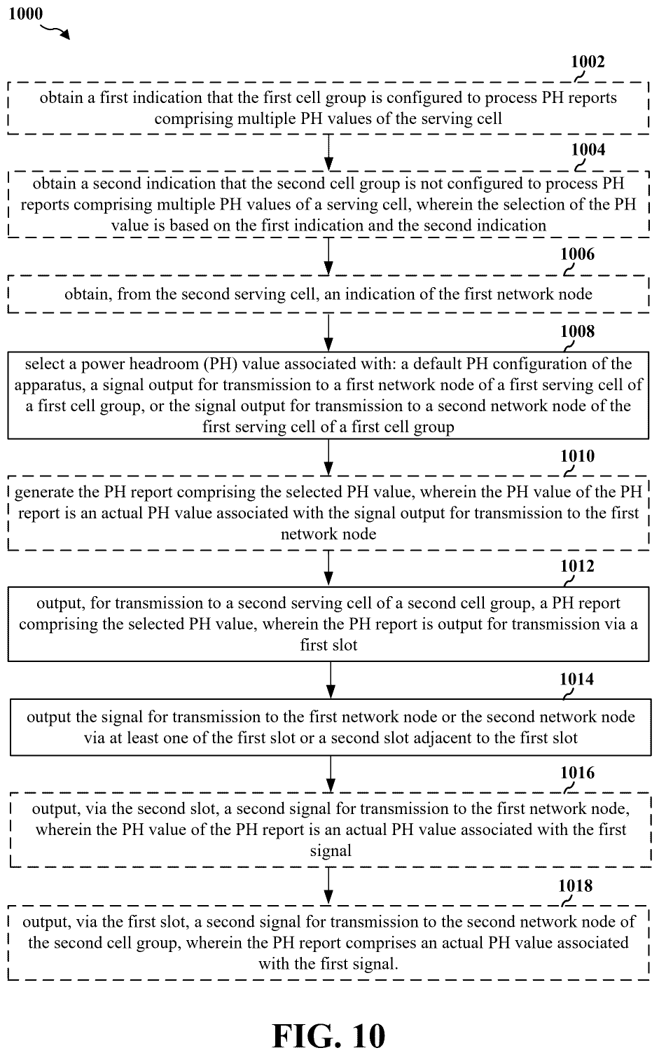

FIG. 10 is a flowchart 1000 of a method of wireless communication. The method may be performed by a UE (e.g., the UE 104; the apparatus 1102). At 1002, the UE may optionally obtain a first indication that the first cell group is configured to process PH reports comprising multiple PH values of the serving cell. For example, 1002 may be performed by a receiving component 1140. Here, the first cell group (e.g., first cell group 602 of FIG. 6) may transmit an indication to the UE that it is configured for twoPHRMode.

At 1004, the UE may optionally obtain a second indication that the second cell group is not configured to process PH reports comprising multiple PH values of a serving cell, wherein the selection of the PH value is based on the first indication and the second indication. For example, 1004 may be performed by the receiving component 1140. Here, the second cell group (e.g., second cell group 604 of FIG. 6) may transmit an indication to the UE that it is not configured for twoPHRMode. Based on the signaling received by the UE from the first cell group in 1002 and the second cell group in 1004, the UE may determine to select only one of a PH value from multiple PH values associated with repeated uplink transmissions to multiple TRPs of a serving cell (e.g., TRP1 612 and TRP2 614 of FIG. 6).

At 1006, the UE may optionally obtain, from the second serving cell, an indication of the first network node. For example, 1006 may be performed by the receiving component 1140. Here, the UE may receive signaling from the second serving cell (e.g., third service cell 610 of FIG. 6), wherein the signaling identifies a particular TRP (e.g., TRP1 612 or TRP2 614) of the first serving cell (e.g., first serving cell 606 of FIG. 6). Because the UE needs to select only one PH value associated with one of the TRPs, the signaling may instruct the UE to include a PH value associated with the identified TRP. This way, when the UE transmits the PH report containing the PH value to the second cell group, the second cell group knows which TRP the PH value corresponds to.

At 1008, the UE may select a power headroom (PH) value associated with: a default PH configuration of the apparatus, a signal output for transmission to a first network node of a first serving cell of a first cell group, or the signal output for transmission to a second network node of the first serving cell of a first cell group. For example, 1008 may be performed by a selecting component 1142. Here, the UE may select one PH value associated with TRP1, TRP2, or a virtual PH value. In some examples, the selected value may be base on the indication received at 1006. In some examples, the UE may be pre-configured to select a particular one of the PH values according to the scenario (e.g., the scenarios illustrated in FIGS. 6-9).

At 1010, the UE may optionally generate the PH report comprising the selected PH value, wherein the PH value of the PH report is an actual PH value associated with the signal output for transmission to the first network node. For example, 1010 may be performed by a generating component 1144. Here, the UE may generate the PH report, and include in the report an actual PH value associated with one of the uplink transmissions to a TRP.

At 1012, the UE may output, for transmission to a second serving cell of a second cell group, a PH report comprising the selected PH value, wherein the PH report is output for transmission via a first slot. For example, 1012 may be performed by a transmitting component 1146. Here, the UE may transmit the PH report to the second serving cell (e.g., third serving cell 610) of FIG. 6.

At 1014, the UE may output the signal for transmission to the first network node or the second network node via at least one of the first slot or a second slot adjacent to the first slot. For example, 1014 may be performed by the transmitting component 1146. Here, the UE may transmit an uplink signal to one of the multiple TRPs of the first serving cell.

At 1016, the UE may optionally output, via the second slot, a second signal for transmission to the first network node, wherein the PH value of the PH report is an actual PH value associated with the first signal. For example, 1014 may be performed by the transmitting component 1146. Here, the UE may transmit another uplink signal to another of the TRPs of the first serving cell.

At 1018, the UE may optionally output, via the first slot, a second signal for transmission to the second network node of the second cell group, wherein the PH report comprises an actual PH value associated with the first signal. For example, 1014 may be performed by the transmitting component 1146. Here, the UE may transmit a PH report (e.g., PH report 622 of FIG. 6).

In certain aspects, the first slot is subsequent in time to the second slot.

In certain aspects, the PH report is output for transmission to the second serving cell via a medium access control-control element (MAC-CE).

In certain aspects, the signal is output for transmission via the first slot, and wherein the PH value of the PH report is an actual PH value associated with the signal.

In certain aspects, the signal is output for transmission via the second slot, and wherein the PH value of the PH report is a virtual PH value associated with the default PH configuration.

In certain aspects, the PH value associated with the first signal is selected based on: (i) the first signal being output for transmission first in time relative to the second signal, or (ii) an indication of the first network node obtained from the first network node.

In certain aspects, the indication is obtained via a radio resource control (RRC) message.

In certain aspects, the PH report comprises a field identifying the first network node or the second network node to which the PH value corresponds.

In certain aspects, the PH report omits all PH values associated with the first serving cell other than the selected PH value.

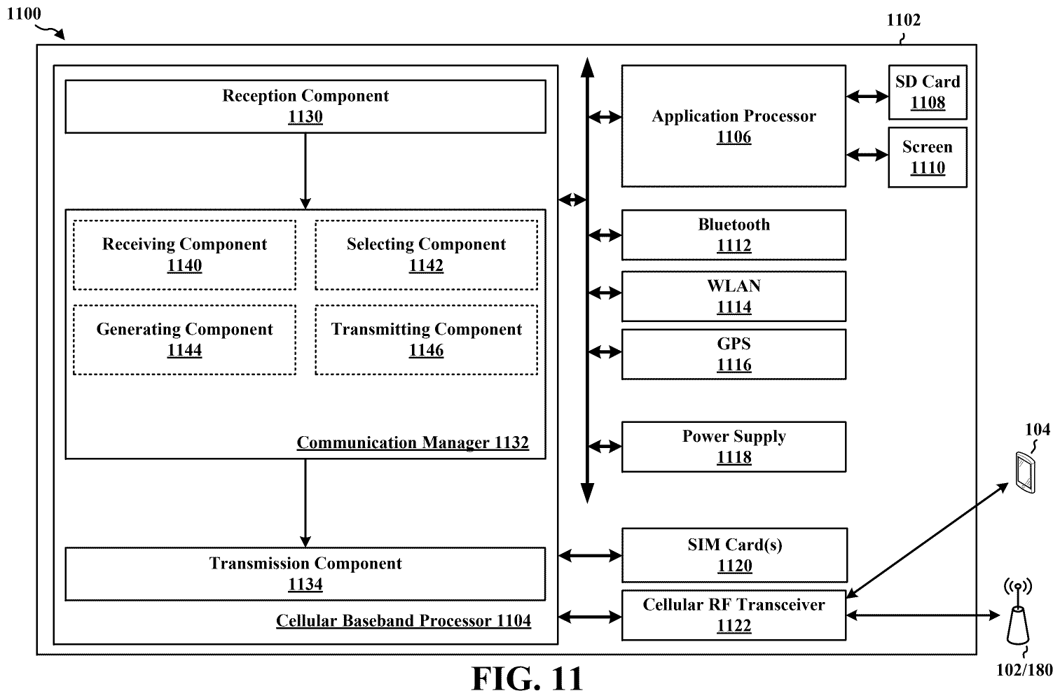

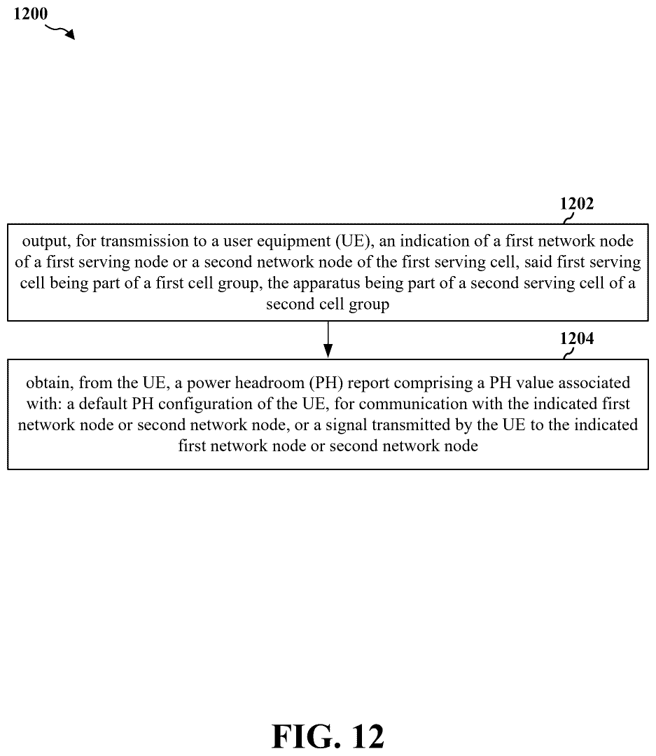

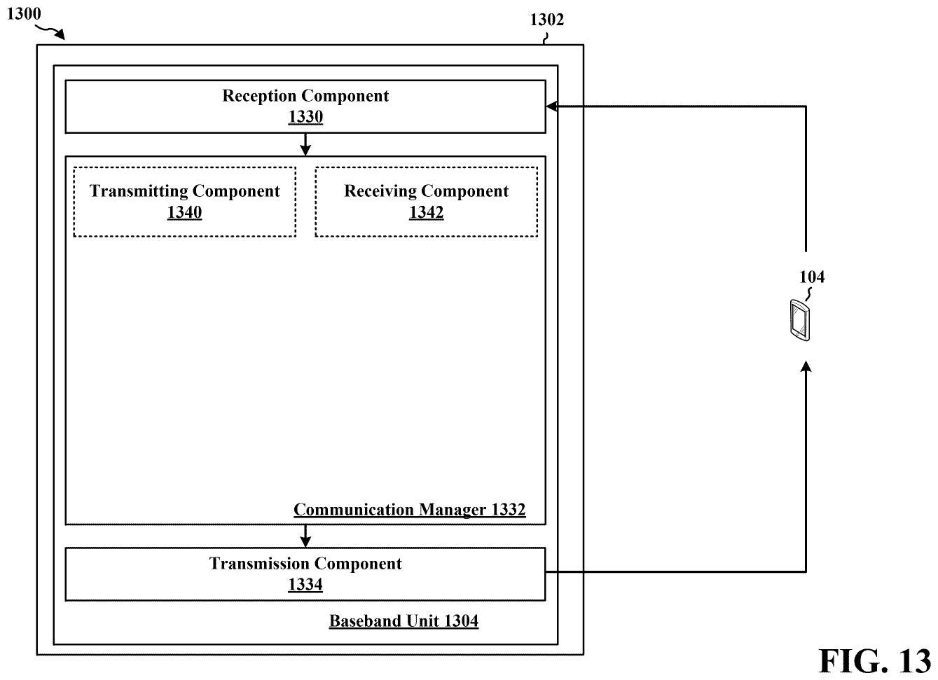

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforediscussed additional modules of the apparatus 1102.

The communication manager 1132 includes a receiving component 1140 that is configured to obtain a first indication that the first cell group is configured to process PH reports comprising multiple PH values of the serving cell; obtain a second indication that the second cell group is not configured to process PH reports comprising multiple PH values of a serving cell, wherein the selection of the PH value is based on the first indication and the second indication; obtain, from the second serving cell, an indication of the first network node; e.g., as described in connection with 1002, 1004, and 1006 of FIG. 10.

The communication manager 1132 further includes a selecting component 1142 configured to select a power headroom (PH) value associated with: a default PH configuration of the apparatus, a signal output for transmission to a first network node of a first serving cell of a first cell group, or the signal output for transmission to a second network node of the first serving cell of a first cell group; e.g., as described in connection with 1008 of FIG. 10.

The communication manager 1132 further includes a generating component 1144 configured to generate the PH report comprising the selected PH value, wherein the PH value of the PH report is an actual PH value associated with the signal output for transmission to the first network node; e.g., as described in connection with 1010 of FIG. 10.

The communication manager 1132 further includes a transmitting component 1146 configured to output, for transmission to a second serving cell of a second cell group, a PH report comprising the selected PH value, wherein the PH report is output for transmission via a first slot; output the signal for transmission to the first network node or the second network node via at least one of the first slot or a second slot adjacent to the first slot; output, via the second slot, a second signal for transmission to the first network node, wherein the PH value of the PH report is an actual PH value associated with the first signal; and output, via the first slot, a second signal for transmission to the second network node of the second cell group, wherein the PH report comprises an actual PH value associated with the first signal; e.g., as described in connection with 1012, 1014, 1016, and 1018 of FIG. 10.

The apparatus may include additional components that perform each of the blocks of the algorithm in the aforementioned flowchart of FIG. 10. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for obtaining a first indication that the first cell group is configured to process PH reports comprising multiple PH values of the serving cell; means for obtaining a second indication that the second cell group is not configured to process PH reports comprising multiple PH values of a serving cell, wherein the selection of the PH value is based on the first indication and the second indication; means for obtaining, from the second serving cell, an indication of the first network node; means for selecting a power headroom (PH) value associated with: a default PH configuration of the apparatus, a signal output for transmission to a first network node of a first serving cell of a first cell group, or the signal output for transmission to a second network node of the first serving cell of a first cell group; means for generating the PH report comprising the selected PH value, wherein the PH value of the PH report is an actual PH value associated with the signal output for transmission to the first network node; means for outputting, for transmission to a second serving cell of a second cell group, a PH report comprising the selected PH value, wherein the PH report is output for transmission via a first slot; means for outputting the signal for transmission to the first network node or the second network node via at least one of the first slot or a second slot adjacent to the first slot; means for outputting, via the second slot, a second signal for transmission to the first network node, wherein the PH value of the PH report is an actual PH value associated with the first signal; and means for outputting, via the first slot, a second signal for transmission to the second network node of the second cell group, wherein the PH report comprises an actual PH value associated with the first signal.

Means for receiving or means for obtaining may include a receiver such as the receive processor 356 and/or antenna(s) 352 of the UE 350 illustrated in FIG. 3. Means for transmitting or means for outputting may include a transmitter such as the transmit processor 368 or antenna(s) 352 of the UE 350 illustrated in FIG. 3. Means for selecting and means for generating may include a processing system, which may include one or more processors, such as the controller/processor 359, the memory 360, and/or any other suitable hardware components of the UE 350 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX

Processor 356, and the controller/processor 359 configured to perform the functions recited by the aforementioned means.

FIG. 12 is a flowchart 1200 of a method of wireless communication. The method may be performed by a network node or a base station (e.g., the base station 102/180; the apparatus 1302. At 1202, the network node may output, for transmission to a user equipment (UE), an indication of a first network node of a first serving node or a second network node of the first serving cell, said first serving cell being part of a first cell group, the apparatus being part of a second serving cell of a second cell group. For example, 1202 may be performed by a transmitting component 1340.

At 1204, the network node may obtain, from the UE, a power headroom (PH) report comprising a PH value associated with: a default PH configuration of the UE, for communication with the indicated first network node or second network node, or a signal transmitted by the UE to the indicated first network node or second network node. For example, 1204 may be performed by a transmitting component 1342.

FIG. 13 is a diagram 1300 illustrating an example of a hardware implementation for an apparatus 1302. The apparatus 1302 is a BS and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a transmitting component 1340 configured to output, for transmission to a user equipment (UE), an indication of a first network node of a first serving node or a second network node of the first serving cell, said first serving cell being part of a first cell group, the apparatus being part of a second serving cell of a second cell group; e.g., as described in connection with 1202.

The communication manager 1332 further includes a receiving component 1342 configured to obtain, from the UE, a power headroom (PH) report comprising a PH value associated with: a default PH configuration of the UE, for communication with the indicated first network node or second network node, or a signal transmitted by the UE to the indicated first network node or second network node; e.g., as described in connection with 1204.

The apparatus may include additional components that perform each of the blocks of the algorithm in the aforementioned flowchart of FIG. 12. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for outputting, for transmission to a user equipment (UE), an indication of a first network node of a first serving node or a second network node of the first serving cell, said first serving cell being part of a first cell group, the apparatus being part of a second serving cell of a second cell group; and means for obtaining, from the UE, a power headroom (PH) report comprising a PH value associated with: a default PH configuration of the UE, for communication with the indicated first network node or second network node, or a signal transmitted by the UE to the indicated first network node or second network node.

Means for receiving or means for obtaining may include a receiver (such as the receive processor 370) and/or an antenna(s) 320 of the network node 310 illustrated in FIG. 3. Means for transmitting or means for outputting may include a transmitter (such as the transmit processor 316) and/or an antenna(s) 320 of the network node 310 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at a user equipment (UE), comprising: selecting a power headroom (PH) value associated with: a default PH configuration of the UE, a signal output for transmission to a first network node of a first serving cell of a first cell group, or the signal output for transmission to a second network node of the first serving cell of a first cell group; outputting, for transmission to a second serving cell of a second cell group, a PH report comprising the selected PH value, wherein the PH report is output for transmission via a first slot; and outputting the signal for transmission to the first network node or the second network node via at least one of the first slot or a second slot adjacent to the first slot.

Example 2 is the method of example 1, wherein the first slot is subsequent in time to the second slot.

Example 3 is the method of any of examples 1 and 2, wherein the PH report is output for transmission to the second serving cell via a medium access control-control element (MAC-CE).

Example 4 is the method of any of examples 1-3, further comprising: obtaining a first indication that the first cell group is configured to process PH reports comprising multiple PH values of the serving cell; and obtaining a second indication that the second cell group is not configured to process PH reports comprising multiple PH values of a serving cell, wherein the selection of the PH value is based on the first indication and the second indication.

Example 5 is the method of any of examples 1-4, wherein the signal is output for transmission via the first slot, and wherein the PH value of the PH report is an actual PH value associated with the signal.

Example 6 is the method of any of examples 1-5, wherein the signal is a first signal, wherein the first signal is output for transmission via the first slot to the first network node, and wherein the method further comprises: outputting, via the second slot, a second signal for transmission to the first network node, wherein the PH value of the PH report is an actual PH value associated with the first signal.

Example 7 is the method of any of examples 1-6, wherein the signal is output for transmission via the second slot, and wherein the PH value of the PH report is a virtual PH value associated with the default PH configuration.

Example 8 is the method of any of examples 1-7, wherein the signal is a first signal, wherein the first signal is output for transmission via the first slot to the first network node, and wherein the method further comprises: outputting, via the first slot, a second signal for transmission to the second network node of the second cell group, wherein the PH report comprises an actual PH value associated with the first signal.

Example 9 is the method of example 8, wherein the PH value associated with the first signal is selected based on: (i) the first signal being output for transmission first in time relative to the second signal, or (ii) an indication of the first network node obtained from the first network node.

Example 10 is the method of any of examples 1-9, wherein the method further comprises: obtaining, from the second serving cell, an indication of the first network node; and generating the PH report comprising the selected PH value, wherein the PH value of the PH report is an actual PH value associated with the signal output for transmission to the first network node.

Example 11 is the method of example 10, wherein the indication is obtained via a radio resource control (RRC) message.

Example 12 is the method of any of examples 1-11, wherein the PH report comprises a field identifying the first network node or the second network node to which the PH value corresponds.

Example 13 is the method of any of examples 1-12, wherein the PH report omits all PH values associated with the first serving cell other than the selected PH value.

Example 14 is a method for wireless communication at a network node, comprising: outputting, for transmission to a user equipment (UE), an indication of a first network node of a first serving node or a second network node of the first serving cell, said first serving cell being part of a first cell group, the apparatus being part of a second serving cell of a second cell group; and obtaining, from the UE, a power headroom (PH) report comprising a PH value associated with: a default PH configuration of the UE, for communication with the indicated first network node or second network node, or a signal transmitted by the UE to the indicated first network node or second network node.

Example 15 is the method of example 14, wherein the PH value is the only PH value associated with the first serving cell.

Example 16 is the method of any of examples 14 and 15, wherein the indication is output for transmission via a radio resource control (RRC) message.

Example 17 is the method of any of examples 14-16, wherein the second cell group is not configured to process PH reports comprising multiple PH values of a serving cell.

Example 18 is the method of any of examples 14-17, wherein the power headroom (PH) report is obtained via a medium access control-control element (MAC-CE), and wherein the MAC-CE comprises a field configured to identify the first network node or the second network node to which the PH value is associated.

Example 19 is a UE, comprising: a transceiver; a memory comprising instructions; and one or more processors configured to execute the instructions to cause the UE to perform a method in accordance with any one of examples 1-13, wherein the transceiver is configured to: transmit the PH report; and transmit the signal.

Example 20 is a network node, comprising: a transceiver; a memory comprising instructions; and one or more processors configured to execute the instructions and cause the network node to perform a method in accordance with any one of examples 14-18, wherein the transceiver is configured to: transmit the indication; and receive the PH report.

Example 21 is an apparatus for wireless communications, comprising means for performing a method in accordance with any one of examples 1-13.

Example 22 is an apparatus for wireless communications, comprising means for performing a method in accordance with any one of examples 14-18.

Example 23 is a non-transitory computer-readable medium comprising instructions that, when executed by an apparatus, cause the apparatus to perform a method in accordance with any one of examples 1-13.

Example 24 is a non-transitory computer-readable medium comprising instructions that, when executed by an apparatus, cause the apparatus to perform a method in accordance with any one of examples 14-18.

Example 25 is an apparatus for wireless communications, comprising: a memory comprising instructions; and one or more processors configured to execute the instructions to cause the apparatus to perform a method in accordance with any one of examples 1-13.

Example 26 is apparatus for wireless communications, comprising: a memory comprising instructions; and one or more processors configured to execute the instructions to cause the apparatus to perform a method in accordance with any one of examples 14-18.

What is claimed is:

1. An apparatus for wireless communication, comprising:
a memory comprising instructions; and
one or more processors configured to execute the instructions and cause the apparatus to:
select a power headroom (PH) value associated with:
a default PH configuration of the apparatus,
a signal output for transmission to a first network node of a first serving cell of a first cell group, or
the signal output for transmission to a second network node of the first serving cell of a first cell group;
output, for transmission to a second serving cell of a second cell group, a PH report comprising the selected PH value, wherein the PH report is output for transmission via a first slot; and
output the signal for transmission to the first network node or the second network node via at least one of the first slot or a second slot adjacent to the first slot.

2. The apparatus of claim 1, wherein the first slot is subsequent in time to the second slot.

3. The apparatus of claim 1, wherein the PH report is output for transmission to the second serving cell via a medium access control-control element (MAC-CE).

4. The apparatus of claim 1, wherein the one or more processors are further configured to:
obtain a first indication that the first cell group is configured to process PH reports comprising multiple PH values of the serving cell; and
obtain a second indication that the second cell group is not configured to process PH reports comprising multiple PH values of a serving cell, wherein the selection of the PH value is based on the first indication and the second indication.

5. The apparatus of claim 1, wherein the signal is output for transmission via the first slot, and wherein the PH value of the PH report is an actual PH value associated with the signal.

6. The apparatus of claim 1, wherein the signal is a first signal, wherein the first signal is output for transmission via the first slot to the first network node, and wherein the one or more processors are further configured to:
output, via the second slot, a second signal for transmission to the first network node, wherein the PH value of the PH report is an actual PH value associated with the first signal.

7. The apparatus of claim 1, wherein the signal is output for transmission via the second slot, and wherein the PH value of the PH report is a virtual PH value associated with the default PH configuration.

8. The apparatus of claim 1, wherein the signal is a first signal, wherein the first signal is output for transmission via the first slot to the first network node, and wherein the one or more processors are further configured to:
output, via the first slot, a second signal for transmission to the second network node of the second cell group, wherein the PH report comprises an actual PH value associated with the first signal.

9. The apparatus of claim 8, wherein the PH value associated with the first signal is selected based on: (i) the first signal being output for transmission first in time relative to the second signal, or (ii) an indication of the first network node obtained from the first network node.

10. The apparatus of claim 1, wherein the one or more processors are further configured to:
obtain, from the second serving cell, an indication of the first network node; and
generate the PH report comprising the selected PH value, wherein the PH value of the PH report is an actual PH value associated with the signal output for transmission to the first network node.

11. The apparatus of claim 10, wherein the indication is obtained via a radio resource control (RRC) message.

12. The apparatus of claim 1, wherein the PH report comprises a field identifying the first network node or the second network node to which the PH value corresponds.

13. The apparatus of claim 1, wherein the PH report omits all PH values associated with the first serving cell other than the selected PH value.

14. A user equipment (UE), comprising:
a transceiver;
a memory comprising instructions; and
one or more processors configured to execute the instructions and cause the UE to:
select a power headroom (PH) value associated with:
a default PH configuration of the apparatus,
a signal transmitted to a first network node of a first serving cell of a first cell group, or
the signal transmitted to a second network node of the first serving cell of a first cell group;
transmit, via the transceiver to a second serving cell of a second cell group, a PH report comprising the selected PH value, wherein the PH report is transmitted via a first slot; and
transmit, via the transceiver, the signal to the first network node or the second network node via at least one of the first slot or a second slot adjacent to the first slot.

15. An apparatus for wireless communication, comprising:
a memory comprising instructions; and
one or more processors configured to execute the instructions and cause the apparatus to:
output, for transmission to a user equipment (UE), an indication of a first network node of a first serving node or a second network node of the first serving cell, said first serving cell being part of a first cell group, the apparatus being part of a second serving cell of a second cell group; and
obtain, from the UE, a power headroom (PH) report comprising a PH value associated with:
a default PH configuration of the UE, for communication with the indicated first network node or second network node, or
a signal transmitted by the UE to the indicated first network node or second network node.

16. The apparatus of claim 15, wherein the PH value is the only PH value associated with the first serving cell.

17. The apparatus of claim 15, wherein the indication is output for transmission via a radio resource control (RRC) message.

18. The apparatus of claim 15, wherein the second cell group is not configured to process PH reports comprising multiple PH values of a serving cell.

19. The apparatus of claim 15, wherein the power headroom (PH) report is obtained via a medium access control-control element (MAC-CE), and wherein the MAC-CE comprises a field configured to identify the first network node or the second network node to which the PH value is associated.

20. The apparatus of claim 15, further comprising a transceiver configured to:
transmit the indication of a first network node; and
receive the PH report, wherein the apparatus is configured as a network node.
